(19) United States
(12) Patent Application Publication
(10) Pub. No.: US 2008/0307321 A1
(43) Pub. Date: Dec. 11, 2008

(54) Method and system for construction document management and distribution

(76) Inventor: Jack Long, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 12/073,266

(22) Filed: Mar. 3, 2008

Related U.S. Application Data
(60) Provisional application No. 60/892,453, filed on Mar. 1, 2007.

(51) Int. Cl. G06F 3/00; G06Q 30/00; G06Q 50/00

(52) U.S. Cl. 715/752; 705/26

(57) ABSTRACT

A method for processing an order for construction document printing comprising receiving a first printing request, wherein the request is comprised of one or more documents that must be printed for one or more users; determining an address associated with each of the one or more users; determining a closest printing facility for each of the one or more users; and sending a second printing request to the closest printing facility for printing the one or more documents associated with each of the one or more users.

This application claims priority from U.S. Patent application No. 60/892,453 that was filed on Mar. 1, 2007.

### FIELD

The methods and systems described herein relate generally to a method and system for online document management, and more specifically to a method and system for distributing and processing orders for construction documents.

### BACKGROUND

Construction projects generally involve a great number of participants who are required to produce and review many documents relating to the project. Generally, the participants in a project would be sent printed documents for review, and such documents would be distributed by the construction managers, architects, consultants or contractors who may be responsible for managing the project. Such methods of providing documents proved to be inefficient, as many participants would receive documents that are not required or out of date for them to complete their respective tasks.

### SUMMARY

In one aspect of the invention, a method for processing an order for construction document printing is provided. The method comprises receiving a first printing request, wherein the request is comprised of one or more documents that must be printed for one or more users; determining an address associated with each of the one or more users; determining a closest printing facility for each of the one or more users; and sending a second printing request to the closest printing facility for printing the one or more documents associated with each of the one or more users.

In another aspect of the invention, a method for online collaboration in a construction document management system is provided. The method comprises: specifying contact information for one or more construction professionals to be invited to join a construction project; sending an electronically transmitted notification to the one or more construction professionals; and receiving confirmation from the one or more construction professionals specifying acceptance or rejection of the invitation.

In another aspect of the invention, a method for construction document distribution is provided. The method comprises placing an order online for one or more construction documents that are to be distributed to one or more construction professionals associated with a construction project; determining the closest printing facility for each of the one or more construction professionals; processing the order by transmitting order information to the closest printing facility for each of the one or more construction professionals; and preparing printouts of the construction documents for the one or more construction professionals.

In another aspect of the invention, a method for online collaboration in a construction document management system is provided. The method comprises displaying one or more construction professionals to select from for potential association with a construction project; selecting one or more of the construction professionals to receive a notification to become members of the construction project; sending an electronic notification to the one or more construction professionals inviting them to access the online administration of the construction project; and receiving confirmation from the one or more construction professionals specifying acceptance or rejection of the invitation.

### BRIEF DESCRIPTION OF THE DRAWINGS

For a better understanding of embodiments of the system and methods described herein, and to show more clearly how they may be carried into effect, reference will be made by way of example to the accompanying drawings in which:

FIG. 1 is a block diagram illustrating the components of the document ordering system;

FIG. 2 is a block diagram illustrating the components of a computing device;

FIG. 3 is a block diagram illustrating the components of a management server;

FIG. 4 is a block diagram illustrating the fields of a document database in an exemplary embodiment;

FIG. 5 is a block diagram illustrating the fields of a user database in an exemplary embodiment;

FIG. 6 is a block diagram illustrating the fields of a project database in an exemplary embodiment;

FIG. 7 is a block diagram illustrating the fields of an order database;

FIG. 8 is a screen shot of a project selection window in an exemplary embodiment;

FIG. 9 is a screen shot of a sample user options window in an exemplary embodiment;

FIG. 10 is a screen shot of a sample category manager window in an exemplary embodiment;

FIG. 11 is a screen shot of a sample size selection window in an exemplary embodiment;

FIG. 12 is a screen shot of a management options window in an exemplary embodiment;

FIG. 13 is a sample role manager window in an exemplary embodiment;

FIG. 14A is a screen shot of a template manager window in an exemplary embodiment;

FIG. 14B is a screen shot of a template manager creation window in an exemplary embodiment;

FIG. 15 is a screen shot of a sample project management window in an exemplary embodiment; and

FIG. 16 is a flowchart illustrating the steps of an order processing method.

### DETAILED DESCRIPTION OF THE INVENTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

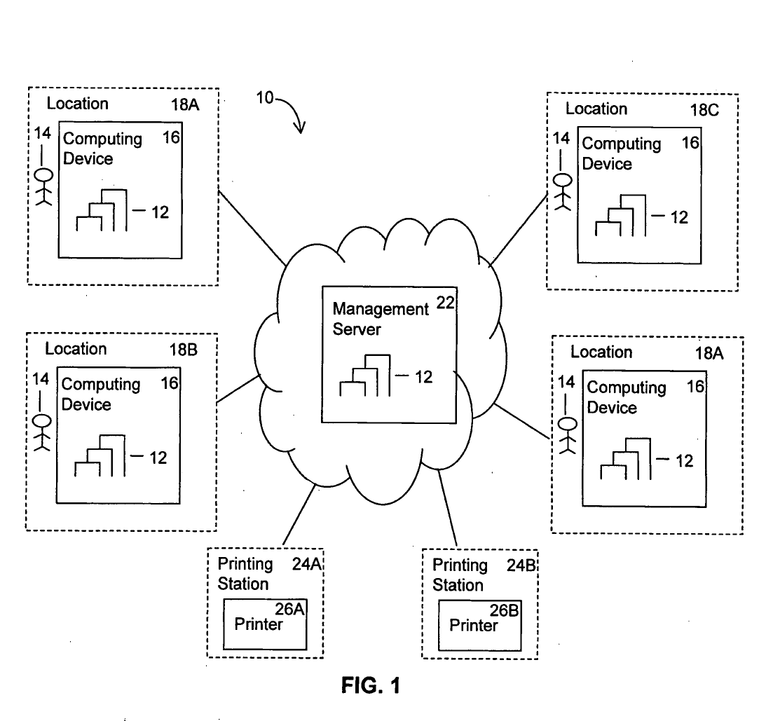

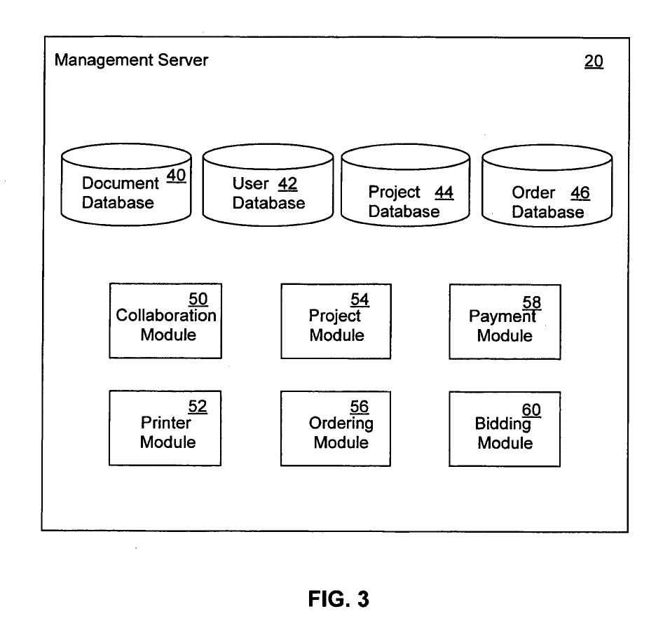

Reference is now made to FIG. 1, where the components of the document ordering system 10 are shown in an exemplary embodiment. The document ordering system 10 in an exemplary embodiment is used to share one or more documents 12 between multiple users 14. The documents in an exemplary embodiment are described as documents that are used in construction projects, and may include but are not limited to, schematic diagrams, architectural drawings, and documents related to cost/pricing that would typically be referred to as engineering documents and specifications. The system 10 is used to share documents among users who require them to work on a specific project or task. The application herein is described with respect to documents that are used in the construction industry, and specifically for document sharing among users who are working on the same construction project. The users 14 may be any user who is granted permission to review and or/edit one or more documents electronically. Each user 14 has associated with them a role that identifies their specific privileges in the project. Roles may include but are not limited to user functions including uploading, downloading, moving, copying, deleting and management functions. As the construction industry has been used for purposes of illustration, users 14 who are part of the same construction project may include architects, consultants, drafts people, electricians, painters, drywallers and other such skilled workers. The users 14 access the documents 12 through a computing device 16. The users 14 and the respective computing device 16 have associated with them a location 18. The location for each user 14 may be different as users 14 may be located anywhere that allows them to access the management server 20. The computing device 16 may be any computing device that has the ability to connect to a communication network 22. The computing device 16 allows the user to perform various operations associated with a document including, but not limited to, storing, viewing, updating, editing, printing and requesting prints of the document 12. The operations that may be performed with respect to a document 12 are described in further detail below. The system 10 stores the documents 12 permanently upon a management server 20 in one embodiment. The management server 20 is described in further detail below with respect to FIG. 3. The management server 20 allows multiple users to perform operations upon the same document 12. The management server 20 may be any computing device that is able to connect to the communication network 22 and may be any computer with appropriate storage capacity. In an exemplary embodiment, the communication network 22 is the Internet. The system 10 also has associated with it one or more printing stations 24. Printing stations comprise a printer 26. The printing stations may be located anywhere geographically. The printing stations 24, as described below, receive requests to print documents 12 from the management server 20 based on requests that have been initiated by users.

Users 14 of the system may use the system in various capacities and will have associated with them certain rights and privileges. The rights and privileges are based on their roles with respect to the operations they may perform. Users 14 of the system 10 will be grouped according to projects. Each project will have associated with it one or more documents and one or more users 14. Both documents and users may belong to more than one project. As the construction industry has been used to describe the system 10, a project will include all of the documents and users involved in one construction project. Each project will have associated with it a project manager and an administrator. The project manager specifies which users may participate in the project and what operations each user is allowed to perform with respect to the documents. The project manager may be the architect, contractor or other similar user that is involved in the project. The administrator creates projects and sets up role standards and invites project managers to project.

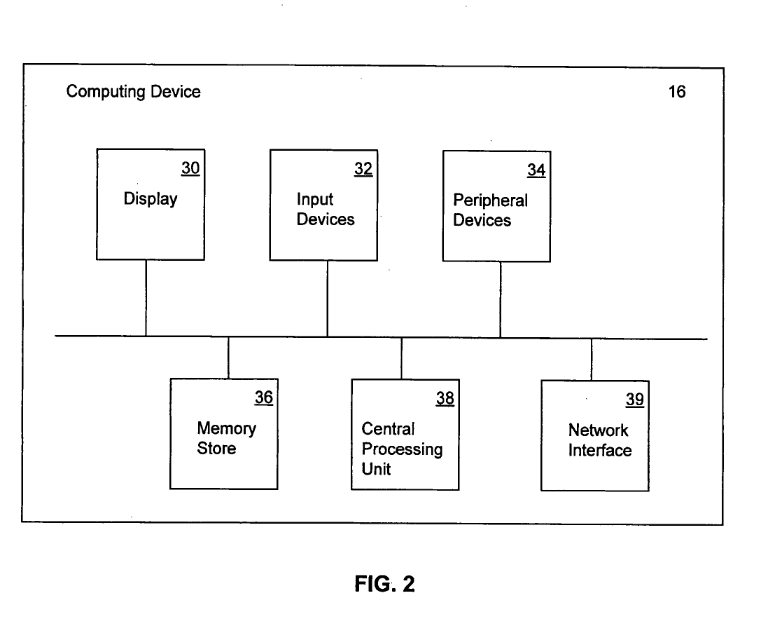

Reference is now made to FIG. 2, where the components of a computing device 16 are illustrated in further detail. The computing device 16 may be any device that connects to a network and allows a user to view files. Computing devices 16 may include but are not limited to personal computers, laptop computers, slim line computers, and hand held computers. The computing device 16 comprises a display 30, input devices 32, peripheral devices 34, a memory store 36, and a central processing unit 38. The display 30 associated with the computing device may be a monitor type device, or built in screen, that allows the user to view content. The input devices 32 may be any device that allows the user to input commands to the computing device 16 and may include, but are not limited to, a keyboard device, a pointing device such as a mouse, a touch screen, or other suitable input device. The peripheral devices 34 may be any peripheral device that is associated with the computing device that may include, but are not limited to, scanners, printers, secondary storage devices, and other such devices. The memory store 36 is the permanent memory storage associated with the computing device. The memory store 36 is used for storage of instructions used in the operation of the computing device, and for storing associated data. In an exemplary embodiment, the memory store 36 may have associated with it a software application (not shown) that allows the user to upload documents to the management server 20. In alternative embodiments, an applet or similar application may be used to perform the uploading and it need not be installed upon the computing device 12. The central processing unit 38 is used to execute commands and instructions that control the operation of the computing device 16. The network interface 39 is used to connect the computing device to a communication network that allows for communication with the management server 20. The network interface 39 may allow for wired or wireless communication with a network.

Reference is now made to FIG. 3, where the components of the management server 20 are shown in an exemplary embodiment. The management server 20 is used for the storage of documents 12, the processing of orders and the management of documents and users. The documents stored upon the management server 20 may be accessed by users 14 through their respective computing devices. In an exemplary embodiment, when the users access the documents 12 from the management server 20, a copy of the document 12 is then stored upon the device 16. The management server 20 allows various computing devices 14 to be connected to the management server 20, and where the user 12 has been granted the appropriate permissions, the user is able to request that certain operations be performed with respect to the documents. The operations may include, but are not limited to, storing, viewing, updating, and ordering the documents and management functions associated with a project and are described in further detail below. Storing of documents refers to the uploading of documents by the user to the management server 20. The documents may be stored initially upon a computing device, or associated storage, from where they are uploaded to the management server 12. As described above, the computing device 16 that is used to upload the construction documents in an exemplary embodiment has installed upon it, or access to, an application that allows it to perform a batch upload function where multiple documents may be uploaded to the management server at one time. The viewing of construction documents allows the users 14 to view the documents 12 that are stored on the management server 20. The documents, as they may be of varying types, may require certain plugins or applications to be installed before the documents may be viewed. When a user selects to view a document, in an exemplary embodiment a copy of the document is first saved to the computing device. The updating of documents by a user involves a user making changes to the document and subsequently having the changed document uploaded to the management server 20. Where a document has been updated, as described in further detail below, a notification which, in an exemplary embodiment may be an electronic mail message, is sent to all users associated with a project informing them that a document that is part of the project has changed. In the construction industry, where it is vitally important that the most up to date documents be used at all stages of any construction project, this allows all of the respective users that are associated with a project to be notified of changes that are to be made. The ordering operations allow the users to submit requests for certain tasks to be carried out with respect to one or more documents that are associated with a project, including printing.

The management server 20, the components of which are shown in FIG. 3, comprises a document database 40, a user database 42, a project database 44, and an ordering database 46. The management server 20 in an exemplary embodiment comprises the following modules which, in an exemplary embodiment, are implemented in software, a collaboration module 50, a printer module 52, a project module 54, an order module 56, and a payment module 58. The modules are described herein as separate modules, for purposes of illustration, but may be combined within one application.

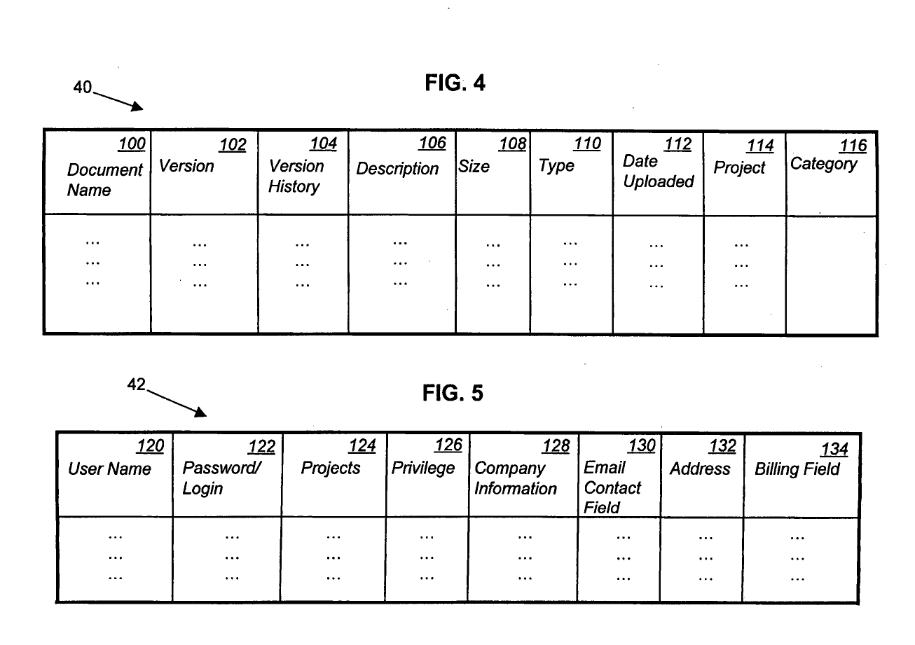

The document database 40 is used to store the various documents that are stored on the management server 20. The document database 40 is described in further detail with respect to FIG. 4 where, in an exemplary embodiment, the fields of the document database are shown. In an exemplary embodiment, the document database 40 comprises a document name field 100, a version field 102, a version history field 104, a description field 106, a size field 108, a document type field 110, a date uploaded field 112, a project field 114 and a category field 116. The document name field 100 is used to store the name of the document. The version field 102 stores the most recent version of the document 12, as the document may have had changes made to it. The version history field 104 stores the previous versions of a document and this allows users to view the previous versions of a document. This may be necessary in a construction environment where the users would like to view previous versions of documents to determine the exact nature of changes that may have been made to any specifications. The description field 106 stores a description of the document. The size field 108 is used to store the size of the electronic version of the document. The type field 110 is used to store information regarding the file type of the document. The date uploaded field 112 is used to store the date at which the document was uploaded to the management server and any other relevant dates that may be associated with the document including the date upon which the document was last revised and the user who uploaded the file. The project field 114 stores the project to which each document is associated. Each project may have associated with it one or more categories. The one or more categories that may be associated with a project may be used to organize and further categorize documents that are associated with a particular project. The category field 116 is used to store information relating to the category to which the document belongs.

The user database 42 is stores information regarding users of the system. Reference is now made to FIG. 5, where the fields of the user database 42 are illustrated in further detail with respect to an exemplary embodiment. The user database 42, in an exemplary embodiment comprises a user name field 120, a password/login field 122, a projects field 124, a privileges field 126, a company information field 128, an email contact field 130, and an address field 132. The user name field 120 stores the user name that is used by the user to access the system 10. The password/login field stores any password or login information that is used to login to the system 10. The projects field 124 stores information pertaining to the various projects to which a user has access. The privileges field 126 stores information related to the various privileges the user has with respect to operations associated with each project. For example, if the user is an administrator of a project, the user is allowed to perform all operations with respect to the documents that are associated with that project. The company information field 128 stores information regarding any company to which the user is associated. The contact field 130 stores contact information of the user that will be used to notify the user of any changes that have been made to documents that are associated with their project and is used to deliver documents when an order is placed for one or more documents by the respective user. The address field 132 is used to determine where the user is located. The use of the address field 132 is explained in further detail below.

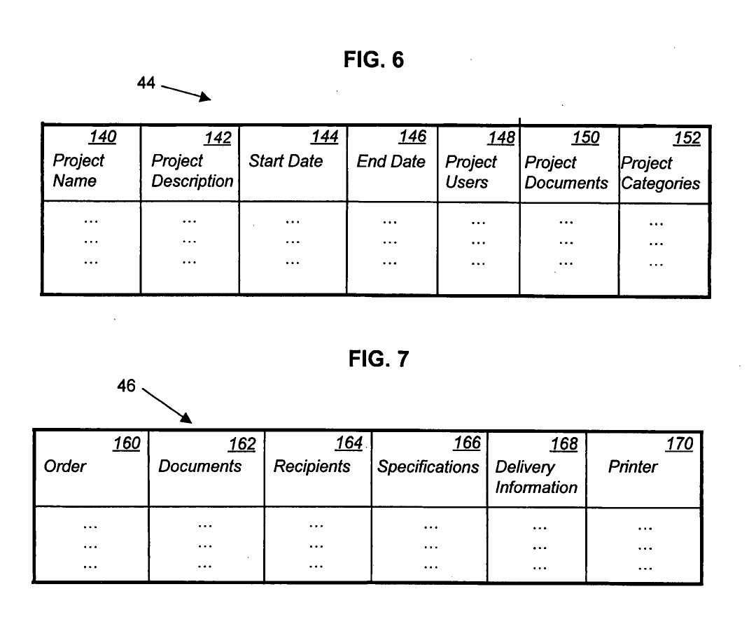

The project database 44 is used to store information regarding the various projects that may be implemented by the system 10. Reference is made to FIG. 6 where, in an exemplary embodiment, the fields of a reference database 44 have been described. The project database 44, in an exemplary embodiment, comprises a project name field 140, a project description field 142, a start date field 144, an end date field 146, a project users field 148, a project documents field 150 and a project categories field 152. The project name field 140 stores the name associated with a project. The project description field 142 stores a description of the project. The start date field 144 stores the date upon which the project was commenced and the project end date field 146 stores the date upon which the project is scheduled to end or has ended. The project users field 148 contains information regarding all of the users that are associated with the project and project document field 150 stores information relating to all of the documents that are associated with this project.

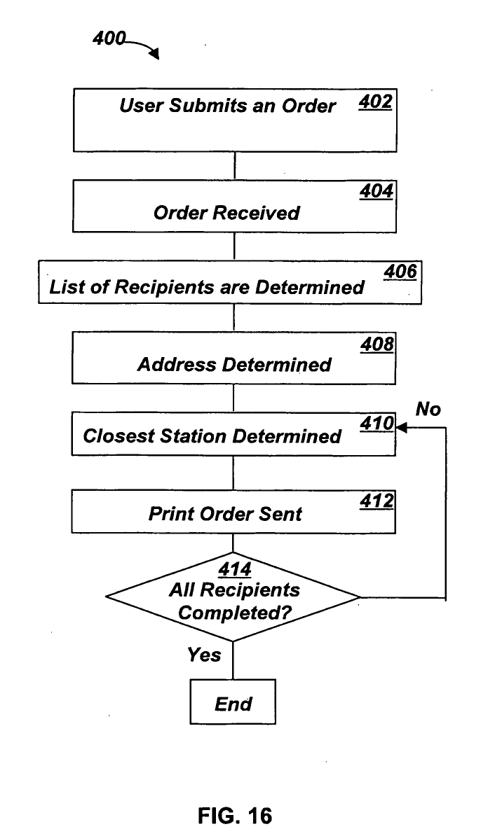

The order database 46 is used to store and track information relating to orders that are placed by users. Users may place orders for one or more documents associated with the project. The user may request that a document be printed and delivered to the user or any other users specified by the user. A user, as described below, has the ability to request that a document be printed for one or more other users that are associated with a project. Reference is now made to FIG. 7, where the fields of an order database are shown in an exemplary embodiment. The ordering database 46, in an exemplary embodiment, comprises an order field 160, a documents field 162, a recipient field 164, a specifications field 166, a delivery information field 168 and a printer field 170. The order field 160 is used to track an order number that is associated with the order that has been made by the user. The documents field 162 stores a record of all of the documents that are part of the order. The recipients field 164 indicates the users that are to receive the order that has been placed. The specifications field 166 stores information pertaining to the size, print quality, quantity and other specifications which are specified in the order. The delivery information field 168 stores information pertaining to the mode of delivery that is to be employed if the order results in a physical document being delivered. The printer field 170 stores the information with regards to the printer which has been chosen to print the order. The method by which the printer is determined is described in further detail below with respect to FIG. 16

Reference is made again to FIG. 3 where various modules that are associated with the management server 10, in an exemplary embodiment, are shown. The collaboration module 50, the printer module 52, the project module 54, and the order module 56 are associated with the management server 10. The collaboration module 50 is a software application that receives requests from users to perform various operations upon the documents, as described below. The collaboration module 50 determines whether the user may perform the requested operation and provides notification to users who are associated with a project when a document has been updated. The printer module 52 is used to determine where an order is to be processed. The project module 54 allows users to create and manage projects. The ordering module 56, as described in further detail below, allows users to place orders with respect to the construction documents. As described above, the various users of the system 10, in an exemplary embodiment, will access the system through the Internet. When a user first accesses the system 10, the user is required to provide authentication information. The user 14, in an exemplary embodiment, provides a login and password. Upon provision of the login and password information, the user is verified as having provided correct login and password information. Where it has been determined that the user has provided correct password and login information, the user is presented with a selection of projects from which they may choose. As mentioned above, for each user, the respective user database 42 stores information pertaining to the various construction projects with which the user is associated.

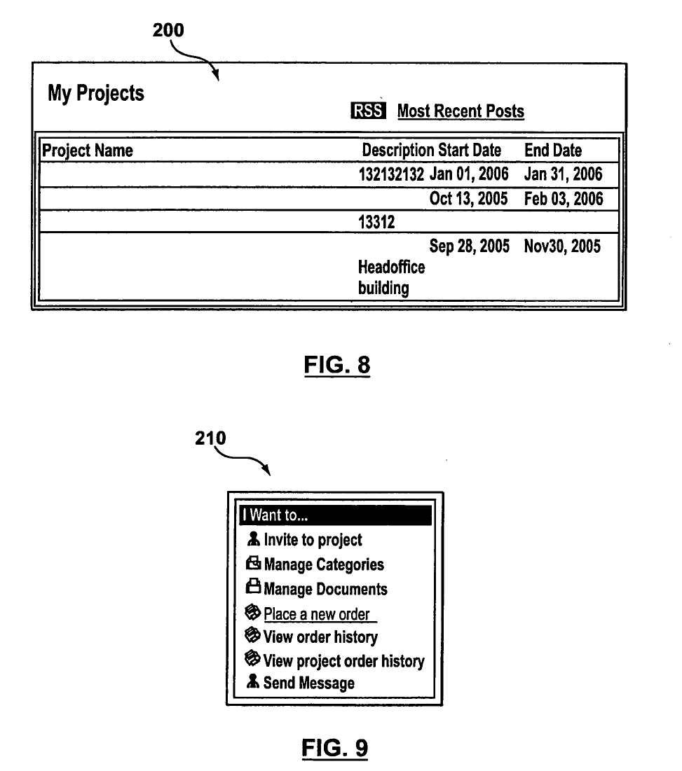

Reference is now made to FIG. 8 where a sample screen shot illustrating a sample display that may be provided to a user when the user logs onto the system 10 is shown. The project window 200 allows a user to select a project from a list of projects with which the user is associated. When a user has selected a specific project, an options window is shown that allows the user to further perform certain tasks. Reference is now made to FIG. 9, where a sample options window 210 is shown in an exemplary embodiment. The options window 210 presents to the user various options with respect to tasks that may be performed. The various tasks include, but are not limited to, inviting others to join a project, managing a category, managing documents, placing orders, viewing orders, and viewing project history. If the user selects to invite a user to a project, an email notification is sent to the user indicating that they have been requested to become a member of a certain project. If the user chooses the manage categories option, the user is able to perform certain tasks associated with respect to categories. Specifically, the user is able to add, edit or delete categories that are associated with a specific project. Where a user has chosen the option of inviting a member to join a project, the user may select from a list of users whose contacts are already registered with the system or may attempt to invite a potential user who has not registered with the construction management system 10. Users who have already registered and are associated with various projects are displayed to the user and the user may select one or more of the users. This, therefore, allows a project manager to ensure that the required construction professionals have been included when work on a specific task is commenced. For example, the project manager may require the addition of certain consultants/tradespeople to the team of users that are involved in a project as the team may not include certain skilled consultants/tradespeople. Consultants may include individuals who provide consulting services for a particular project and tradespeople may include, but are not limited to, individuals who provide on-site services. Therefore, upon selection of one or more of the users to invite, in an exemplary embodiment, an electronic mail message is sent to request the users to become a member of a particular project. The project manager, along with being able to invite users who are already registered users, may invite potential users who are not registered users of the system. The project manager will be requested to enter the name and address and to select the role or task that the user is being asked to implement. An electronic mail message will then be sent to the proposed member specifying who the initiator of such a request is, details regarding the project they are being asked to be involved with and information on how to sign up (a link is provided outlining how the user may sign up).

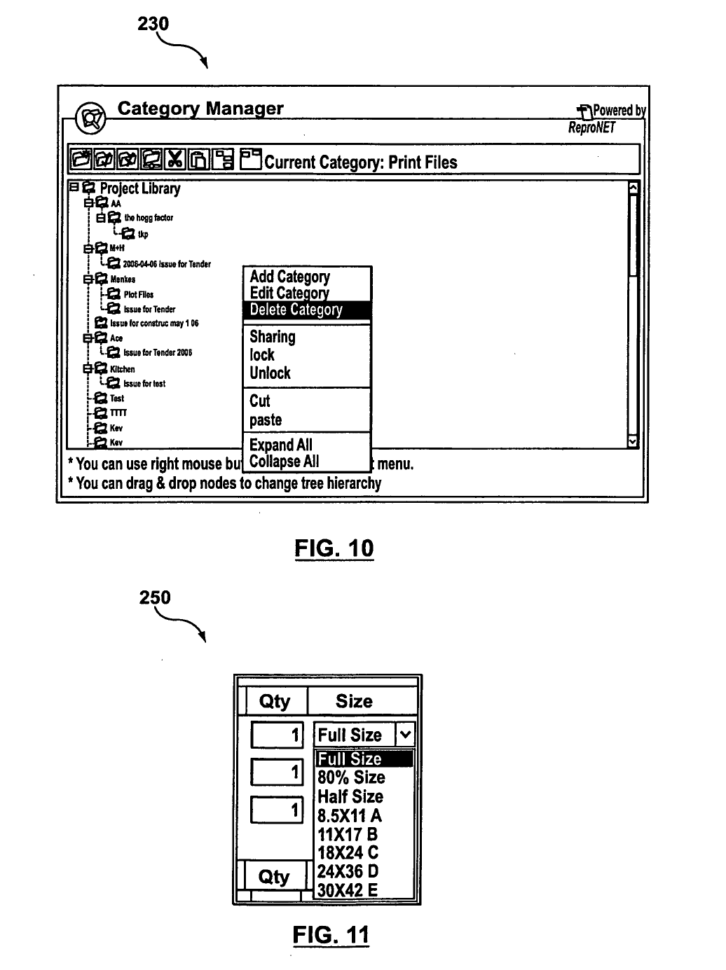

Reference is now made to FIG. 10, where a sample category manager window 230 is shown in an exemplary embodiment. A category manager window 230 is displayed and provided to the user where the user has chosen to manage a category. The category manager 230 window as shown in FIG. 10 is shown for purposes of example. The category manager window 230 displays the various categories that are associated with a specific project. For each category, the user is presented with various options including deleting the category, editing the category, sharing, locking and unlocking the category. When the user chooses to share a category, this allows the user to specify the privileges that will be given to other users who may be associated with this category. In an exemplary embodiment, the user is presented with the two options when specifying the privileges that are associated with a category. The user may specify that all users who are associated with this category should be granted full privileges. Also, the various users who are associated with a project may require access for various purposes. The user may specify privileges by user. A category may be shared with users who are associated with specific roles. Read-only access that is provided to the categories results in the users only being able read the document and request prints of the documents.

Referring again to FIG. 9, the user may choose to manage documents. Where the user has selected to manage documents, the user may upload, download, move and/or delete documents. The user, when uploading documents, may upload one or more documents and associate them with a specific category. The collaboration module examines all of the files that are uploaded to determine whether they are suitable file types. Where the user has uploaded more than one document with the same file name, the collaboration module assigns a version number to the second document that was uploaded and assigns the document version number two. The user is also provided with the option to download documents. The various users who are associated with a construction project may wish to download the documents for subsequent review. The user may also select the option of moving documents, where a document may be moved from one category to another.

As shown in an exemplary embodiment of the options presented to a user, the user, when a project is first selected, also has the option of placing a new order. When an order is placed for one or more construction documents, the user is able to specify the documents they wish to order, the recipients of the order and specific information that is then used in the preparation of the documents. In an exemplary embodiment, the user may choose to place the order by category of documents or by individual documents associated with a project. By allowing the user the option to place an order by category, this allows the user to make sure that all of the construction professionals have received all of the documents that are associated with a category. By ensuring that all of the documents relating to a category have been received by all of the construction professionals, the project manager will have to facilitate the distribution of documents to all those involved in the particular task or project. A user is also provided with the functionality to track the orders that have been placed by other users, as described below. This ensures that a project manager is able to determine whether any of the members of a construction project still require documents for completion of their respective tasks.

Where a user places an order by category, the user will select the various recipients who are to receive the documents and will specify the quantity and print specifications associated with each document for each recipient. More specifically, in an exemplary embodiment, where the project manager has chosen to request that documents be printed, the project manager is asked to specify a priority for delivery, the quantity of each document and the size of each document that is to be printed. The delivery priorities indicate whether the documents should be delivered to the recipients on a priority basis. Reference is now made to FIG. 11, where a sample size selection window 250 is shown. The size selection window presents options to the users where the user may specify the size of the document that is to be printed. The size specification may be completed for each document that the various recipients are to receive.

The user may also choose to place an order for the documents individually. Where the user has selected to place an order for the documents individually, the project manager must specify the various documents that are being ordered, one or more recipients for each documents and specific information regarding each document, including the priority, quantity and size. The method by which the document order is processed by the management server is described in further detail below with respect to FIG. 16.

Referring to FIG. 9 and the sample options window 210, when the user selects the option of viewing an order history, an order history window is shown to the user. The order history window will list all of the orders that have been placed by the user where the orders are indexed by their purchase order number.

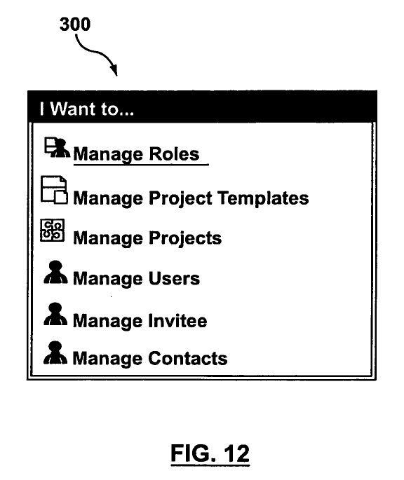

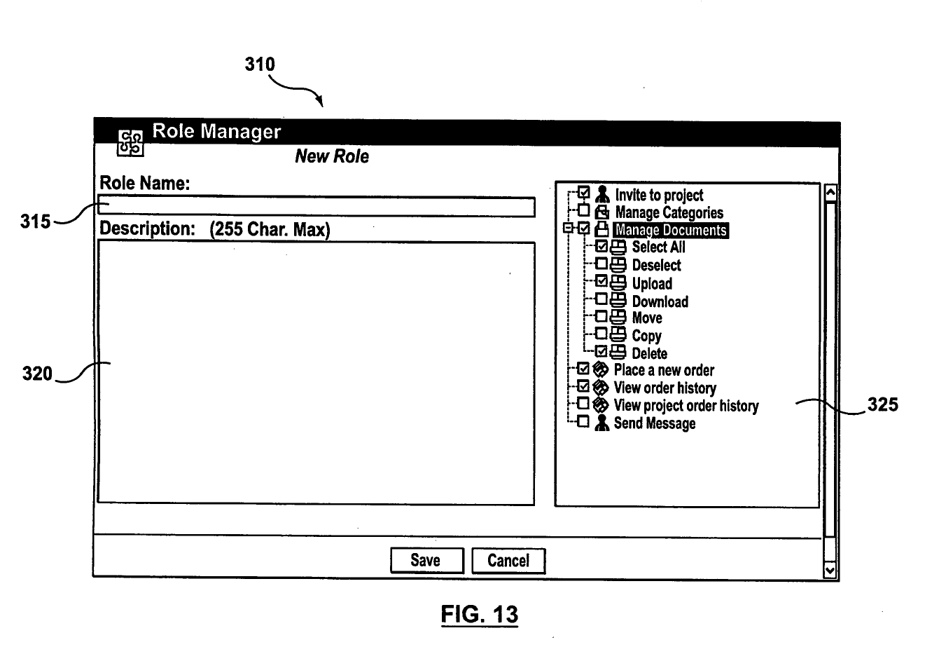

The sample options window 210 illustrates in one exemplary embodiment the options that are presented to any user of the system 10 upon authentication. The respective administrators and project managers have additional functionality available to them that is not available to a user who does not have administrative privileges. Reference is now made to FIG. 12, where a sample of a management options window 300 is shown. The management options window 300 presents the administrative user with various options that allows the administrative user to manage the various users and projects that are associated with the project. More specifically, the administrative user is presented with the following options in an exemplary embodiment: managing roles, managing templates, managing projects, managing users, managing invitees and managing contacts. The options presented in the management options window 300 are described in further detail with reference to FIG. 13-15.

Reference is now made to FIG. 13 where a sample role manager window 310 is shown in an exemplary embodiment. The role manager window 310 comprises a role definition field 315, a role description field 320, and a role actions window 325. The role definition field 315 is used to enter the name of a new role that is being defined by the administrative user. The role description field 320 is used to provide a description of the role that is being created. The role action field 325 is used to specify the actions that a user who is associated with the role being defined is allowed to perform in an exemplary embodiment.

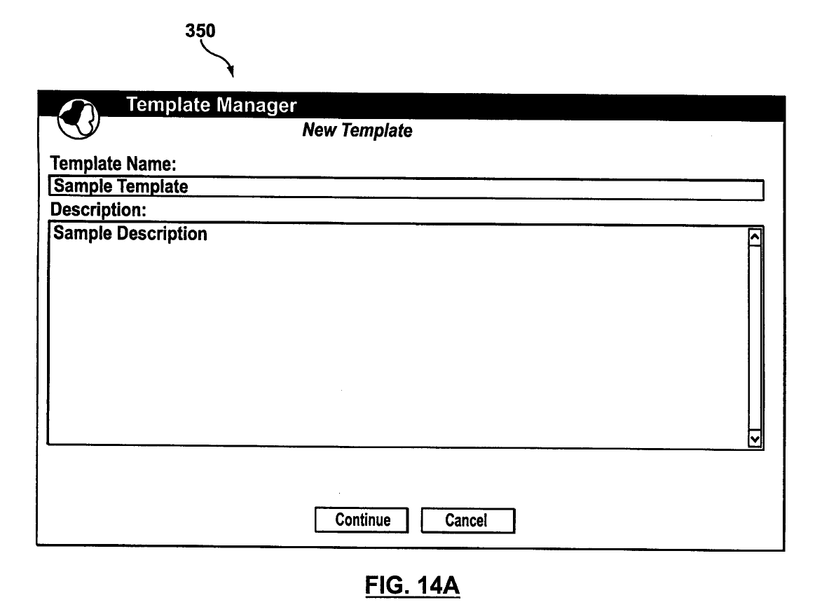

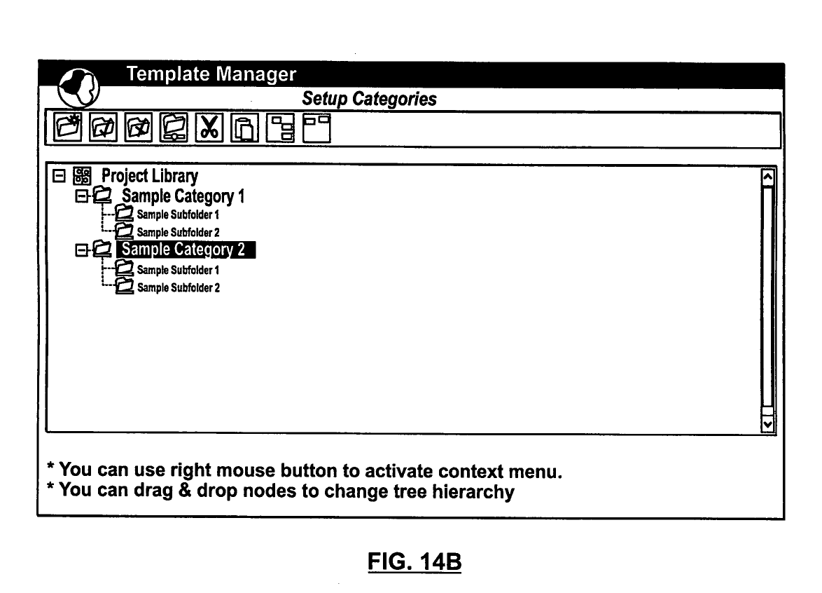

Reference is now made to FIG. 14A where a sample template manager window 350 is shown. The administrative user may define one or more templates that are used to automatically populate a newly created project with respective categories. The administrative user may set up default categories and sub categories. For example, the administrative user may request that for each project a category be created that is to be used for the cost of the project and another one for mechanical drawings that are used in the respective construction project. The template manager creation window 350 allows the administrative user to create a new template and the template manager specification window 355, as shown in FIG. 14B, allows the user to specify various categories and subcategories that are associated with each template.

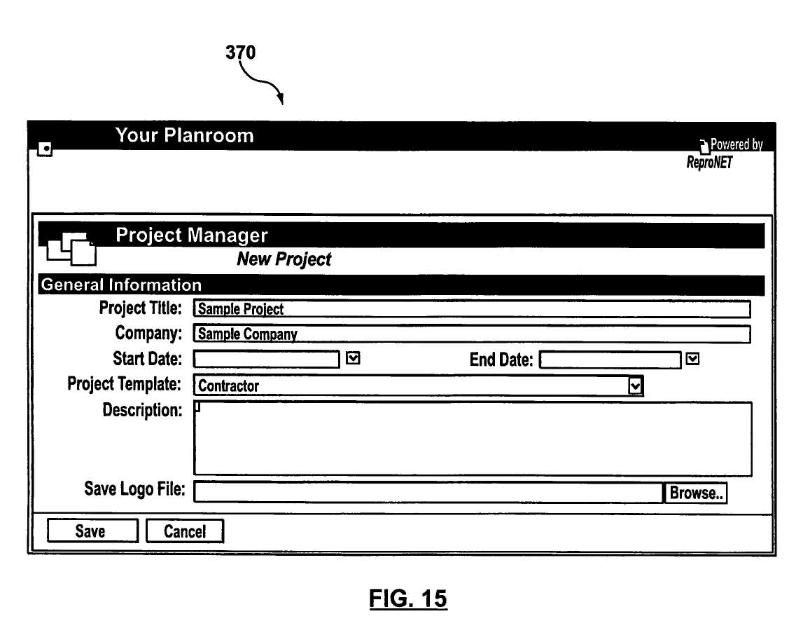

Reference is now made to FIG. 15, where a sample project management window 370 is shown in an exemplary embodiment. The project management window 370 is engaged by the administrative user when a project is created. The administrative user, in an exemplary embodiment, is requested to enter the title of the project, the company, the start date, the end date and the type of project (which would be selected from the list of templates that have been defined). Once a project has been created, the administrative user can invite various users to join the project and check the status of the users who have been requested to join a project. Where the administrative user wishes to check the status of the users who have been requested to join a specific project, the administrator will select the manager users option that is displayed in FIG. 13.

When the user has selected the option of managing users, a list of all of the users that are associated with a particular project is displayed. Each user will have associated with them a status indicator. If a user has not accepted the invitation to be a member of a project, their status will be listed as pending. The administrative user may also disable a user's access to a certain project.

Reference is now made to FIG. 16 where the steps of an order processing method 400 are shown. The order processing method 400 is implemented by the management server where a user has placed an order and the order is received by the management server 20. Method 400 processes the order by determining the respective recipients that are associated with the order and by specifying a printing facility that will be used to print the documents that have been requested for each recipient. As the various users who are associated with a particular construction project may be located in various geographic areas, method 400 determines the printing requirements and sends the printing order electronically to a printing facility that is located in geographic proximity to the respective user. This allows the user to be able to pick up the printed documents or for the printing facility to ship the printed documents to the user such that shipping costs and the time involved are reduced.

Method 400 begins at step 402 where the user submits an order. As discussed above, the order will specify one or more documents for printing, the one or more recipients associated with the documents and the printing preferences that are associated with each document. Method 400 then proceeds to step 404 where the order is received at the management server. An administrator associated with the management server 20, in an exemplary embodiment, will receive an e-mail message indicating that an order has been submitted. The management server 20 receives the order electronically as the management server 20 is connected to the computing station 14 upon which the order was generated through a communication network 22.

Method 400 then proceeds to step 406. At step 406, the list of recipients is determined. Method 400 then proceeds to step 408 where the physical location of reach recipient is determined. The address of each recipient is stored in the user database 42. Method 400 then proceeds to step 410 where, for each recipient, the supplier database is checked to determine the printing station that is closest to the recipient. Method 400 then proceeds to step 412 where a print order is sent electronically to the respective printing station 24. The electronic print order may be sent via fax, email or other similar methods. Method 400 then proceeds to step 414 where a check is performed to determine if any recipients remain for whom the printing station remains to be determined. If, at step 414, it is determined that recipients remain as part of the order, method 400 returns to step 410. If it is determined at step 414 that no further recipients remain to be processed, method 400 ends.

The present invention has been described with regard to preferred embodiments, however, it will be obvious to persons skilled in the art that a number of variants and modifications can be made without departing from the scope of the invention as described herein.

1. A method for online collaboration in a construction document management system, the method comprising:
a) displaying one or more construction professionals to select from for potential association with a construction project;
b) selecting one or more of the construction professionals to receive a notification to become members of the construction project;
c) sending an electronic notification to the one or more construction professionals inviting them to access the online administration of the construction project; and
d) receiving confirmation from the one or more construction professionals specifying acceptance or rejection of the invitation.

2. The method of claim 1, wherein the construction professionals may be selected from a group comprising consultants and tradespeople.

3. The method of claim 1, wherein the electronic notification is an e-mail message.

4. A method for online collaboration in a construction document management system, the method comprising:
a) specifying contact information for one or more construction professionals to be invited to join a construction project;
b) sending an electronically transmitted notification to the one or more construction professionals; and
c) receiving confirmation from the one or more construction professionals specifying acceptance or rejection of the invitation.

5. The method of claim 4, wherein the construction professionals may be selected from the group comprising consultants and tradespeople.

6. The method of claim 4, wherein the electronic notification is an e-mail message.

7. The method of claim 4, wherein the electronic transmittal may be sent via facsimile.

8. A method for construction document distribution, the method comprising:
a) placing an order online for one or more construction documents that are to be distributed to one or more construction professionals associated with a construction project;
b) determining the closest printing facility for each of the one or more construction professionals;
c) processing the order by transmitting the order information to the closest printing facility for each of the one or more construction professionals; and
d) preparing printouts of the construction documents for the one or more construction professionals.

9. The method of claim 8, wherein the one or more construction professionals are notified that printouts are ready through electronic notification.

10. A method for processing an order for construction document printing comprising:
a) receiving a first printing request, wherein the request is comprised of one or more documents that must be printed for one or more users;
b) determining an address associated with each of the one or more users;
c) determining a closest printing facility for each of the one or more users; and
d) sending a second printing request to the closest printing facility for printing the one or more documents associated with each of the one or more users.
